(19) United States
(12) Patent Application Publication
(10) Pub. No.: US 2013/0013570 A1
(43) Pub. Date: Jan. 10, 2013

(54) FILE STORAGE APPARATUS, DATA STORING METHOD, AND DATA STORING PROGRAM

(75) Inventor: Satoshi Yamakawa, Tokyo (JP)

(73) Assignee: NEC CORPORATION, Minato-ku, Tokyo (JP)

(21) Appl. No.: 13/634,130

(22) PCT Filed: Mar. 11, 2011
(86) PCT No.: PCT/JP2011/001437

§ 371 Date: Sep. 11, 2012

(30) Foreign Application Priority Data
Mar. 29, 2010 (JP) 2010-075766

(51) Int. Cl. G06F 17/30

(52) U.S. Cl. 707/679; 707/E17.007

(57) ABSTRACT

An extraction unit extracts, in accordance with a format of a file which the client apparatus requests a file storage apparatus to store to storing means, data possibly made into independent data as an independent file from the file which is data in a portion that can be stored to the storing means. A duplicate determination unit determines whether the storing means stores data matching the data possibly made into independent data that is extracted by the extraction unit or remaining data which are data obtained by deleting the data possibly made into independent data from the file. A storing processing unit stores, to the storing means, the data possibly made into independent data or the remaining data which do not match data stored to the storing means, on the basis of the determination result made by the duplicate determination unit. A restoring unit restores a file by connecting the remaining data and the data possibly made into independent data which are stored to the storing means by the storing processing unit, in accordance with a request made by the client apparatus.

### TECHNICAL FIELD

This invention relates to a file storage apparatus shared by one or more client apparatuses, a data storing method and a data storing program for the file storage apparatus.

### BACKGROUND ART

A storage apparatus centrally storing data generated by multiple client apparatuses uses a method called de-duplication to reduce the amount of data stored physically. In this method, when data are stored to a physical storage medium such as a hard disk, a determination is made as to whether the data match already-stored data, and instead of storing repeating data to the storage medium, only pointer information pointing to the already-stored repeating data is recorded.

In the de-duplication, in general, a determination as to whether data to be stored match already-stored data is made in units of files or in units of physical data blocks allocated in a fixed manner when a file system stores data to a storage medium. Accordingly, data from which repeated data are removed are stored, whereby the amount of data recorded physically is reduced (for example, see patent literature 1).

In the de-duplication, in general, a determination as to whether data to be stored match already-stored data is made in units of files or in units of physical data blocks allocated in a fixed manner when a file system stores data to a storage medium. In the duplicate determination, small digest data having sizes of several tens to several hundred bits generated using a hash function such as SHA1 (Secure Hash Algorithm 1) and MD5 (Message Digest 5) used for digital authentication and the like are compared with each other to make the determination, so that the determination is made as to whether the data are a file or a data block constituted by the same byte string. By employing the duplicate determination method using digest data, the processing cost required in the duplicate determination executed on the storage apparatus is reduced. In particular, in storage processing which is expected to execute high-speed input/output processing, there is an advantage in that the deterioration of performance of the input/output processing can be reduced by performing duplicate determination at the same time as the input/output processing.

In particular, a de-duplication-type storage system employing the duplicate determination method using digest data is applied to an environment where many files and data blocks constituted by the same byte string are expected. More specifically, this de-duplication-type storage system is widely applied as one of means for reducing the cost of data storage in a storage apparatus of which object is to store image data of system portions of multiple virtual operating systems and a storage apparatus of which object is to store backup data.

It should be noted that patent literature 2 describes a system for preventing image files from being stored repeatedly. In the system described in patent literature 2, a determination is made as to whether an input image file matches an image file already recorded to an image file recording system, and when the input image file matches the image file already recorded to the image file recording system, the input image file is not stored.

### CITATION LIST

### Patent Literature

PLT 1: Japanese Patent Application Laid-Open No. 2008-158993
PLT 2: Japanese Patent Application Laid-Open No. 2006-92268

### SUMMARY OF INVENTION

### Technical Problem

However, in a general de-duplication, duplicate determination units such as units of files or in units of physical data blocks allocated in a fixed manner when a file system stores data to a storage medium are used. In such case, when file data are changed or data are inserted by a user and the like, the change of the data and the file data before and after the insertion are deemed to be different file data even if the amount of change and the amount of insertion is extremely little. When the duplicate determination unit is the physical data block unit, a dividing method for division into physical data blocks is in a fixed manner. Therefore, there is a problem in that, even if most of data in file data match data already stored to a storage medium, the data are not detected as repeated data. More specifically, the physical amount of data to be stored to a storage apparatus is not sufficiently reduced, and the cost of storing file data is not reduced sufficiently.

Accordingly, it is an exemplary object of this invention to provide a file storage apparatus, a data storing method, and a data storing program capable of reducing the cost of storing file data by reducing the physical amount of data to be stored.

### Solution to Problem

A file storage apparatus according to this invention is a file storage apparatus having storing means for storing data in accordance with a request given by a client apparatus, and the file storage apparatus includes an extraction unit which extracts, in accordance with a format of a file which the client apparatus requests the file storage apparatus to store to storing means, data possibly made into independent data as a independent file from the file, the data possibly made into independent data being data in a portion that can be stored to the storing means, a duplicate determination unit which determines whether the storing means stores data matching the data possibly made into independent data that is extracted by the extraction unit or remaining data which are data obtained by deleting the data possibly made into independent data from the file, a storing processing unit which stores, to the storing means, the data possibly made into independent data or the remaining data which do not match data stored to the storing means, on the basis of the determination result made by the duplicate determination unit, and a restoring unit which restores a file by connecting the remaining data and the data possibly made into independent data which are stored to the storing means by the storing processing unit, in accordance with a request made by the client apparatus.

A data storing method according to this invention is a data storing method for storing data to storing means of a file storage apparatus in accordance with a request given by a client apparatus, the data storing method including extracting, in accordance with a format of a file which the client apparatus requests the file storage apparatus to store to storing means, data possibly made into independent data as a independent file from the file, the data possibly made into independent data being data in a portion that can be stored to the storing means, determining whether the storing means stores data matching the extracted data possibly made into independent data or remaining data which are data obtained by deleting the data possibly made into independent data from the file, storing, to the storing means, the data possibly made into independent data or the remaining data which do not match data stored to the storing means, on the basis of the determination result, and restoring a file by connecting the remaining data and the data possibly made into independent data which are stored to the storing means, in accordance with a request made by the client apparatus.

A data storing program according to this invention is a data storing program provided in a file storage apparatus having storing means for storing data in accordance with a request given by a client apparatus, and the data storing program causes a computer to execute extraction processing for extracting, in accordance with a format of a file which the client apparatus requests the file storage apparatus to store to storing means, data possibly made into independent data as a independent file from the file, the data possibly made into independent data being data in a portion that can be stored to the storing means, duplicate determination processing for determining whether the storing means stores data matching the data possibly made into independent data that is extracted in the extraction processing or remaining data which are data obtained by deleting the data possibly made into independent data from the file, storing processing for storing, to the storing means, the data possibly made into independent data or the remaining data which do not match data stored to the storing means, on the basis of the determination result made by the duplicate determination processing, and restoring processing for restoring a file by connecting the remaining data and the data possibly made into independent data which are stored to the storing means in the storing processing in accordance with a request made by the client apparatus.

### Advantageous Effects of Invention

According to this invention, the physical amount of data to be stored is reduced, whereby the cost of storing file data can be more reduced.

### BRIEF DESCRIPTION OF DRAWINGS

FIG. 1 It depicts a block diagram illustrating a configuration of a storage system including an embodiment of a file storage apparatus according to this invention.

FIG. 2 It depicts a block diagram illustrating an internal configuration of the file storage apparatus illustrated in FIG. 1.

FIG. 3 It depicts a flowchart illustrating file writing processing of the file storage apparatus illustrated in FIG. 1.

FIG. 4 It depicts a flowchart illustrating file reading processing of the file storage apparatus illustrated in FIG. 1.

FIG. 5 It depicts a flowchart illustrating file delete processing of the file storage apparatus illustrated in FIG. 1.

FIG. 6 It depicts a block diagram illustrating a main portion of the file storage apparatus according to this invention.

### DESCRIPTION OF EMBODIMENTS

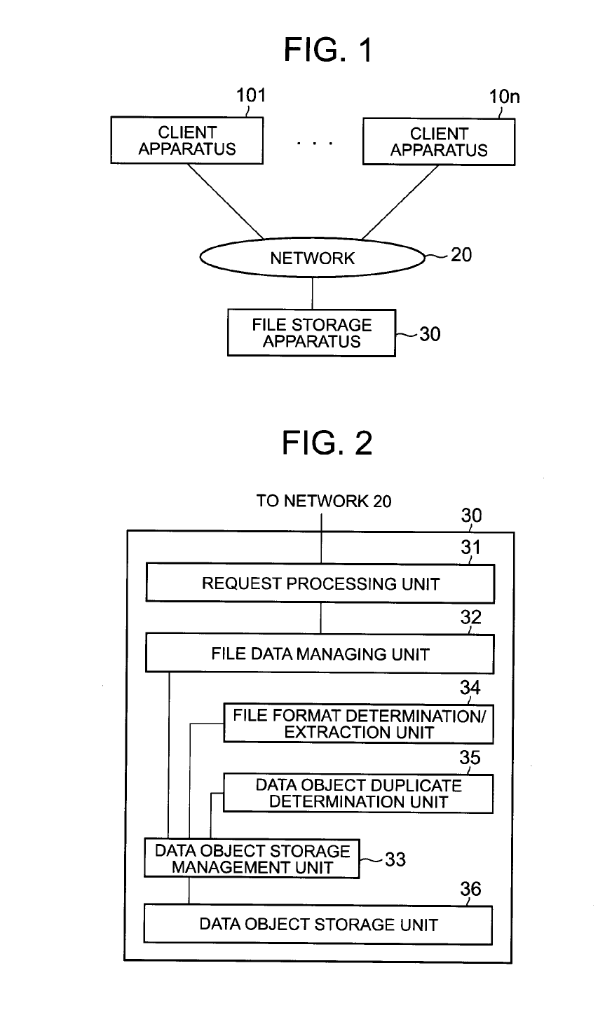

FIG. 1 is a block diagram illustrating a configuration of a storage system including an embodiment of a file storage apparatus according to this invention. The storage system including a file storage apparatus 30 which is an embodiment of the file storage apparatus according to this invention will be explained with reference to FIG. 1.

The storage system illustrated in FIG. 1 includes at least one or more client apparatuses 101 to 10n and the file storage apparatus 30. The client apparatuses 101 to 10n and the file storage apparatus 30 are connected with each other via a network 20.

The client apparatuses 101 to 10n transmit file data processing requests such as a new generation request and a deleting request of file data to the file storage apparatus 30 and a reading request and a writing request of file data stored in the file storage apparatus 30. Hereinafter, the client apparatus 101 will be explained. However, the client apparatuses 102 to 10n operate in the same manner as the client apparatus 101.

The file storage apparatus 30 executes, in accordance with a file data processing request transmitted from the client apparatus 101 via the network 20, new generation processing of a file (i.e., processing for storing a file in accordance with a storing request of a file transmitted from the client apparatus 101 via the network 20), delete processing, and a reading processing and a writing processing of file data stored in the storage apparatus 30. Then, the file storage apparatus 30 transmits an execution result of processing to the client apparatus 101, which originally made the processing request, via the network 20.

FIG. 2 is a block diagram illustrating an internal configuration of a file storage apparatus illustrated in FIG. 1. The internal configuration of the file storage apparatus 30 will be explained with reference to FIG. 2.

The storage apparatus 30 includes a request processing unit 31, a file data managing unit 32, a data object storage management unit 33, a file format determination/extraction unit 34, a data object duplicate determination unit 35, and a data object storage unit 36.

The request processing unit 31 receives the file data processing request transmitted from the client apparatus 101 via the network 20. The request processing unit 31 outputs the contents of the processing request and the file data to the file data managing unit 32 in accordance with the received file data processing request. When the request processing unit 31 receives a completion notification of file data processing from the file data managing unit 32, the request processing unit 31 transmits, via the network 20, a completion notification of file data processing to the client apparatus 101 which originally made the file data processing request.

The file data managing unit 32 functions as a file system within the file storage apparatus 30. The file data managing unit 32 generates file ID information uniquely representing a file, manages various kinds of meta-data given to the file, and manages a directory tree configuration. The file data managing unit 32 determines whether various kinds of processing request transmitted from the client apparatus 101 is executable or not on the basis of the meta-data.

The data object storage management unit 33 manages information indicating a configuration of a data object constituting file data managed by the file data managing unit 32 and manages storage destination address information indicating a storage position of the data object in the data object storage unit 36. Further, the data object storage management unit 33 executes reading processing for reading data object from the data object storage unit 36 in accordance with a request given by the file data managing unit 32 and executes writing processing for writing data object to the data object storage unit 36 in accordance with a determination result provided by the data object duplicate determination unit 35.

The file format determination/extraction unit 34 determines, on the basis of the file format information of file data, whether there is a data object that can be extracted as a data portion, which can be saved as an independent file, from a data object constituting the file data (hereinafter referred to as a sub-data object). Further, the file format determination/extraction unit 34 executes extraction processing for extracting a sub-data object which is determined to be extractable.

The file format determination/extraction unit 34 performs forming processing for forming the remaining data obtained by removing the sub-data object portion from the file data (hereinafter referred to as a main data object) after the sub-data object is extracted.

The data object duplicate determination unit 35 performs duplicate determination for determining whether data object already stored to the data object storage unit 36 and data object which is to be newly registered to the data object storage unit 36 involve any repeated data therein. Further, the data object duplicate determination unit 35 executes registration processing for registering data in accordance with determination result. In addition, the data object duplicate determination unit 35 executes delete processing for deleting data registered in the data object storage unit 36.

The data object storage unit 36 includes at least one or more storage media such as a hard disk. The data object storage unit 36 writes a data object to a storage medium, deletes a data object from a storage medium, and reads a data object from a storage medium in accordance with requests given by the data object storage management unit 33 and the data object duplicate determination unit 35.

Now, a management method of a data object in the data object storage management unit 33 will be explained in detail.

The data object storage management unit 33 uses a data object management table to manage data objects. There are two kinds of data object management tables. One of the two kinds of data object management tables is a sub-data object management table for managing sub-data objects, which are data objects extracted by the file format determination/extraction unit 34 from a file. The other of the two kinds of data object management tables is a main data object management table for managing a main data object constituting file data of the file in a portion other than the sub-data object.

The data object storage management unit 33 registers, to the main data object management table, ID (main data object ID) information for uniquely identifying a main data object, ID (sub-data object ID) information for uniquely identifying all the sub-data objects extracted from the main data object, information indicating a connecting method of the main data object and the sub-data object when the sub-data object is extracted, a storage destination address information of the main data object in the data object storage unit 36, and flag information indicating whether the saving processing for saving the main data object to the data object storage unit 36 has been finished or not (main data object save completion flag). It should be noted that information indicating the connecting method of the main data object and the sub-data object includes, information indicating for example, an insertion position at which the sub-data object is inserted into the main data object.

The data object storage management unit 33 registers, to the sub-data object management table, sub-data object ID information for uniquely identifying a sub-data object, a storage destination address information about the sub-data object in the data object storage unit 36, and flag information indicating whether the saving processing for saving the sub-data object to the data object storage unit 36 has been finished or not (sub-data object save completion flag).

Subsequently, extraction processing for extracting a sub-data object and forming processing of a main data object after the sub-data object has been extracted which are performed by the file format determination/extraction unit 34 will be explained in detail.

First, in the file format determination/extraction unit 34, the type of a sub-data object which may be incorporated into file data (for example, jpg and bmp) and the extraction method of the sub-data object incorporated are set in advance as supported file information in accordance with the type of a file extension (for example, xls). In the type of a file extension in the supported file information, the type of an application file format (for example, PDF format) according to application software (for example, Adobe Reader (registered trademark)) may be set.

The file format determination/extraction unit 34 looks up setting of the supported file information for the file format information (file extension) of file data which are input from the data object storage management unit 33, and extracts, from the input file data, data portion incorporated into the file as binary data which can be extracted, saved, and restored as an independent file such as image data and video data, as a sub-data object. More specifically, the file format determination/extraction unit 34 extracts, from the input file data, a sub-data object in accordance with the extraction method of the sub-data object set in the supported file information in accordance with the file format information of the input file data.

The file format determination/extraction unit 34 inspects the file data from the head of the file data so as to find whether the file data includes incorporated control tag information about a data object that can be extracted as an independent file such as image data and video data. It should be noted that the control tag information is different according to the file format. The file format determination/extraction unit 34 selects control tag information which is to be detected, in accordance with the file format information of the file given by the data object storage management unit 33. The control tag information which is to be detected may be included in the supported file information.

When the file data includes incorporated control tag information, the file format determination/extraction unit 34 extracts a data object which can be extracted as an independent file as a sub-data object, on the basis of the control tag information.

The file format extraction unit 34 extracts the sub-data object from the file, and thereafter, generates, as a main data object, a data object formed by deleting the sub-data object from the file. Then, the file format determination/extraction unit 34 generates insertion position information indicating the insertion position where the sub-data object is inserted into the main data object. More specifically, the insertion position information is information indicating a position where the main data object and the sub-data object are connected. The insertion position information includes, for example, offset position information indicating a position from the head of the main data object and length information indicating the data length of the sub-data object.

When there are multiple sub-data objects to be extracted, the file format determination/extraction unit 34 extracts all the sub-data objects to be extracted, and generates insertion position information for each of the sub-data objects.

When the file does not include any control tag information, the file format determination/extraction unit 34 completes processing since there is no sub-data object.

Subsequently, information registration processing and information delete processing used for storing a file which are processing performed by the data object duplicate determination unit 35 will be explained in detail.

The data object duplicate determination unit 35 has a function of calculating hash values of a main data object and a sub-data object to be stored to the data object storage unit 36, using a hash function set in advance. In addition, the data object duplicate determination unit 35 has a hash table for managing the calculated hash values, storage destination address information of data of the main data object and the sub-data object in the data object storage unit 36, and the number of times data are repeated, which are associated with each other.

The registration processing of information is executed when the data object storage management unit 33 issues, to the data object duplicate determination unit 35, a registration command of data in accordance with a storing request of a file transmitted via the network 20 from the client apparatus 101, and outputs it together with the main data object and the sub-data object to be stored to the data object storage unit 36.

The data object duplicate determination unit 35, which has received the registration command of the data, calculates hash values of the main data object and the sub-data object which is output from the data object storage management unit 33. Then, the data object duplicate determination unit 35 confirms whether a hash value matching the calculated hash value is registered in the hash table or not. More specifically, the data object duplicate determination unit 35 makes duplicate determination in units of data object.

When a hash value matching the calculated hash value is registered in the hash table, the data object duplicate determination unit 35 obtains storage destination address information of data registered in the hash table associated with the corresponding hash value. Then, the data object duplicate determination unit 35 adds one to the number of times data are repeated, and notifies the storage destination address information of the data to the data object storage management unit 33. The registration processing of the information has been finished hereinabove.

In order to avoid false detection of repeated data when the same hash value is calculated on the basis of different data objects, the data object duplicate determination unit 35 may have a repeated data false detection preventing function. In this false detection preventing function, when the matching hash value is registered in the hash table, the data object duplicate determination unit 35 reads the data stored in the data object storage unit 36 on the basis of the storage destination address information of the data associated with the hash value. Further, in this false detection preventing function, the data object duplicate determination unit 35 confirms whether the read data and the main data object which is to be newly stored and the byte string of the data of the sub-data object are consistent with each other.

When the data object duplicate determination unit 35 determines that the hash value matching the calculated hash value is not registered in the hash table, the data object storage management unit 33 stores the main data object or the sub-data object, which are to be newly stored, to a vacant data storage region of the data object storage unit 36. The data object duplicate determination unit 35 associates the calculated hash value, the storage destination address information of the main data object and the sub-data object in the data object storage unit 36, and data in which the number of times data are repeated is set as zero, and stores, to the hash table, the calculated hash value, the storage destination address information of the main data object and the sub-data object in the data object storage unit 36, and the data in which the number of times data are repeated is set as zero. Then, the data object duplicate determination unit 35 notifies the storage destination address information of the data to the data object storage management unit 33. The registration processing of the information has been finished hereinabove.

The delete processing of information is executed when the data object storage management unit 33 issues, to the data object duplicate determination unit 35, a delete command of the main data object or the sub-data object in accordance with a deleting request of a file transmitted via the network 20 from the client apparatus 101, and outputs it together with the storage destination address information of the main data object or the sub-data object to be deleted.

The data object duplicate determination unit 35, which has received the delete command of the main data object or the sub-data object, extracts the storage destination address information of the hash table corresponding to the storage destination address information of the main data object or the sub-data object which is output from the data object storage management unit 33.

Then, data object duplicate management unit 35 confirms the number of times data are repeated which is associated with the extracted storage destination address information. When the number of times data are repeated is 0, the data object duplicate management unit 35 deletes the main data object and the sub-data object recorded in the data object storage managing unit 36 on the basis of the storage destination address information. Then, the data object duplicate management unit 35 notifies the data object storage management unit 33 that the delete processing of the information has been finished. The delete processing of the information has been finished hereinabove.

When the number of times data are repeated is equal to or more than 1, the data object duplicate management unit 35 decreases the number of times data are repeated by one. Then, the data object duplicate management unit 35 notifies the data object storage management unit 33 that the delete processing of the information has been finished. The delete processing of the information has been finished hereinabove.

In the storage system as illustrated in FIG. 1, a file access request such as new generation, deleting, reading, and writing of a file given from the client apparatus 101 to the file storage apparatus 30 is executed using a network file system protocol which has become de facto standard such as NFS (Network File System) and a CIFS (Common Internet File System). When the client apparatus 101 requests the file storage apparatus 30 to store a new file, the client apparatus 101 makes a file access request of new generation and writing of a file.

For example, when the file access request is made, the request processing unit 31 provided in the storage apparatus 30 interprets various kinds of network file system protocols, and the various kinds of file access requests are transferred to the file data managing unit 32. When the file data managing unit 32 finishes the file access processing, the request processing unit 31 converts the completion notification of the file access processing on the basis of the various kinds of network file system protocols, and the converted completion notification is transferred to the client apparatus 101.

Processing in which the file storage apparatus 30 generates a new file in the storage system as illustrated in FIG. 1 will be explained. It should be noted that the processing for generating a new file is processing which is performed when the file is newly stored to the data object storage unit 36 in accordance with a request made by the client apparatus 101.

First, the request processing unit 31 receives a new generation request for requesting new generation of a file from the client apparatus 101. The request processing unit 31 transmits the new generation request, a directory name in which the file is generated, a file name, and other meta-data information about the file to the file data managing unit 32.

When the file data managing unit 32 receives the directory name in which the file is generated, the file name, and other meta-data information about the file from the request processing unit 31, the file data managing unit 32 generates file ID information uniquely identifying a file unless there is any problem in data generation permission such as writing permission of the file. Then, the file data managing unit 32 saves meta-data managed in the file system generated on the basis of various kinds of meta-data information specified in such a manner that the meta-data are associated with the generated file ID information. When the meta-data and the file ID information have been saved, the file data managing unit 32 transmits new generation completion notification of the file and the generated file ID information to the request processing unit 31. The request processing unit 31 transmits the received new generation completion notification of the file and the file ID information of the file to the client apparatus 101.

When delete processing of a file, writing processing of a file data, and reading processing of file data are performed by a file access request, a file to be processed is specified using a file ID information generated in the new generation processing of the file.

Subsequently, processing performed by the file storage apparatus 30 to write a file in accordance with a request of the client apparatus 101 will be explained. The processing for writing a file is processing which is performed when a file is newly stored to the data object storage unit 36 in accordance with a request made by the client apparatus 101 or when the file already stored to the data object storage unit 36 is updated. When a file is newly stored to the data object storage unit 36, processing for newly generating a file explained above is performed, and thereafter, processing for writing the file is executed using the generated file ID information.

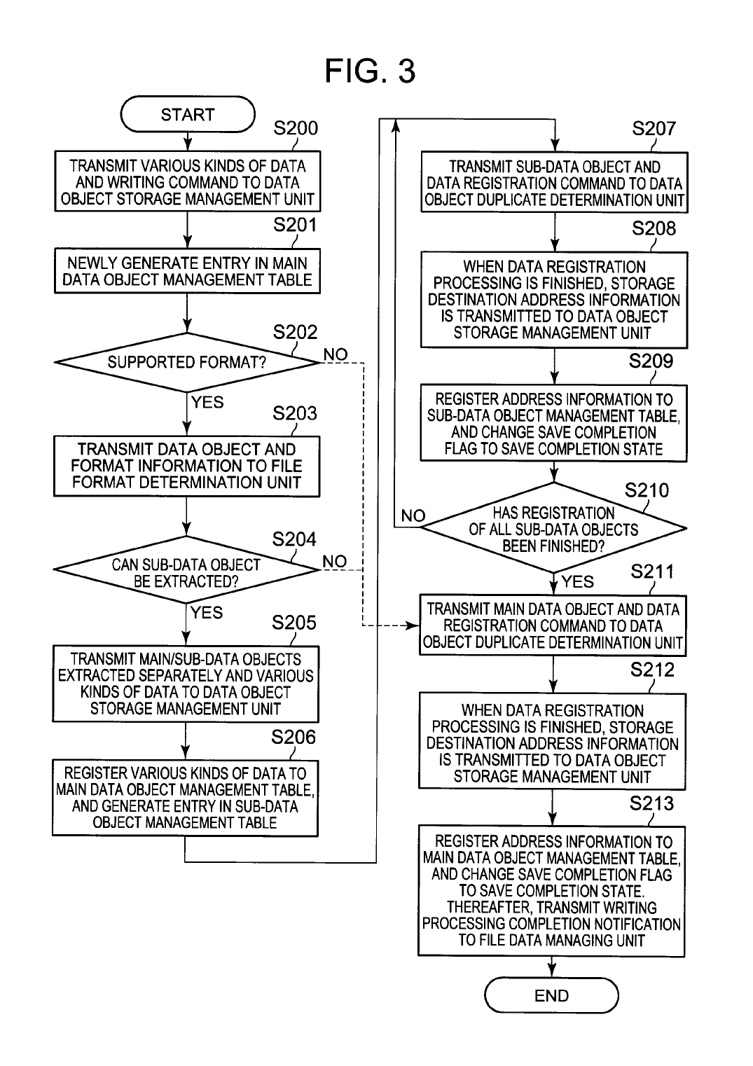

FIG. 3 is a flowchart illustrating file writing processing of the file storage apparatus illustrated in FIG. 1. Writing processing in which the file storage apparatus 30 writes file data in the storage system as illustrated in FIG. 1 will be explained with reference to FIG. 3.

First, the request processing unit 31 receives, from the client apparatus 101, a file writing command for requesting writing of file data and file ID information of the file to which the file data are written. Along with the transfer of the file writing command, the request processing unit 31 transmits the file ID information of the file to be written and the main body of the file data to be written, to the file data managing unit 32.

The file data managing unit 32, which has received the file writing command, transmits the file ID information, the data object writing command, the main body of the file data of the data object, and the extension of the file name given to the file (i.e., file format information) to the data object storage management unit 33, on the basis of the file ID information and the main body of the file data received from the request processing unit 31 (step S200).

The data object storage management unit 33, which has received the data object writing command, newly generates an entry having the same main data object ID information as the received file ID information to the main data object management table. Then, the data object storage management unit 33 sets the main data object save completion flag of the entry to a state indicating that the saving processing has not yet been finished (step S201).

Subsequently, the data object storage management unit 33 determines whether the file format information received from file data managing unit 32 is a file format with which the file format determination/extraction unit 34 can determine whether there is any sub-data object and can extract it (supported file format) (step S202). Whether the file format information is a supported file format can be determined by determining whether a file extension matching the file format information received from the file data managing unit 32 is registered in the types of file extensions of the supported file information.

When the file format information is a supported file format by the file format determination/extraction unit 34 in step S202, the data object storage management unit 33 transmits the data object and file format information, which are received from the file data managing unit 32, to the file format determination/extraction unit 34 (step S203).

The file format determination/extraction unit 34 determines whether the sub-data object can be extracted from the received data object, on the basis of the file format information received from the data object storage management unit 33 (step S204).

When the sub-data object is determined to be extractable in step S204, the file format determination/extraction unit 34 executes extraction processing of the sub-data object determined to be extractable from the data object. Then, the file format determination/extraction unit 34 deletes the sub-data object extracted from the data object in the extraction processing, and performs forming processing for generating a main data object which is a data object from which the sub-data object has been deleted. Then, the file format determination/extraction unit 34 replies, to the data object storage management unit 33, the extracted sub-data object, the generated main data object, the number of sub-data objects extracted, and insertion position information about the insertion position where the sub-data object is inserted into the main data object (step S205).

When the sub-data object is determined not to be extractable in step S204 (N in step S204), the file format determination/extraction unit 34 replies, to the data object storage management unit 33, that the sub-data object cannot be extracted. In the subsequent processing, the same processing as the processing executed when the file format information is not a supported file format by the file format determination/extraction unit 34 in step S202 (N in step S202) is executed.

When the sub-data object is extracted, and the data group is replied from the file format determination/extraction unit 34 in step S205, the data object storage management unit 33 gives, to the sub-data object management table, sub-data object ID information for uniquely identifying the sub-data objects in accordance with the number of sub-data objects given in the reply. Then, the data object storage management unit 33 generates entry information in which a sub-data object save completion flag indicating that the saving processing of sub-data objects has not yet finished is set. In addition, the data object storage management unit 33 registers, to the main data object management table, related sub-data object ID information and insertion position information of the sub-data objects (step S206).

Subsequently, the data object storage management unit 33 transmits the sub-data object together with the registration command of the data to the data object duplicate determination unit 35 (step S207).

The data object duplicate determination unit 35 performs duplicate determination for determining repeated data in the sub-data object transmitted from the data object storage management unit 33, and executes data registration processing which is registration processing of the data object in accordance with the determination result. More specifically, the data object duplicate determination unit 35 calculates a hash value of the sub-data object transmitted from the data object storage management unit 33. Then, when the calculated hash value does not match the hash value registered in the hash table in the data object storage unit 36, the data object duplicate determination unit 35 determines that no repeated data are stored. At this occasion, the data object duplicate determination unit 35 outputs the sub-data object to the data object storage management unit 33, and commands the data object storage unit 36 to store the sub-data object. The data object storage management unit 33 stores the sub-data object to the data object storage unit 36 in accordance with the command. After the data registration processing is finished, the data object duplicate determination unit 35 notifies the data object storage management unit 33 of data storage destination address information of the data object storage unit 36 indicating the storage destination of the data (step S208).

The data object storage management unit 33, which is notified of the storage destination address information of the data by the data duplicate determination unit 35, registers the storage destination address information to the target entry of the sub-data object management table of the data, and sets the sub-data object save completion flag to a state indicating that the saving processing has been finished (step S209).

The data object storage management unit 33 confirms whether the data registration processing has been finished for all the sub-data objects extracted in step S205 (step S210). Then, after the data registration processing is finished, the data object storage management unit 33 transmits the registration command of the data and the main data object to the data object duplicate determination unit 35 (step S211).

When the file format information is determined to be a file format that is not supported by the file format determination/extraction unit 34 in the determination processing as shown in step S202 (No in step S202), the data object storage management unit 33 adopts the data object transferred from the file data managing unit 32 as the main data object, and like the operation as illustrated in step S211, the data object storage management unit 33 transmits the registration command of the data as well as the main data object to the data object duplicate determination unit 35.

The data object duplicate determination unit 35 which has received the data of the main data object and the registration command of the main data object performs duplicate determination for determining repeated data in the main data object, and executes data registration processing which is registration processing of the data object in accordance with the determination result. More specifically, the data object duplicate determination unit 35 calculates the hash value of the main data object transmitted from the data object storage management unit 33. Then, when the calculated hash value does not match the hash value registered in the hash table in the data object storage unit 36, the data object duplicate determination unit 35 determines that no repeated data are stored. At this occasion, the data object duplicate determination unit 35 outputs the main data object to the data object storage management unit 33, and commands the data object storage unit 36 to store the main data object. The data object storage management unit 33 stores the main data object to the data object storage unit 36 in accordance with the command. After the data registration processing is finished, the data object duplicate determination unit 35 notifies the data object storage management unit 33 of data storage destination address information of the data object storage unit 36 (step S212).

The data object storage management unit 34 which has received the data storage destination address information determines whether the main data object management table includes an entry having the same main data object ID conflicting with that of the writing processing target.

When the main data object management table includes an entry having the same main data object ID (for example, this corresponds to update processing of file data), the data object storage management unit 34 transmits, to the data object duplicate management unit 35, a delete command of all the sub-data objects and main data object managed by the entry having the conflicting main data object ID. After the delete processing for all the objects is finished, the data object storage management unit 34 deletes the entry having the conflicting main data object ID and the entries in the sub-data object management table of the related sub-data objects. Then, the data object storage management unit 34 registers the storage destination address information to the entry of the main data object which is the data writing target. Further, the data object storage management unit 34 sets the main data object save completion flag of the entry to a state indicating that the saving processing has been finished. Further, the data object storage management unit 34 notifies the file data managing unit 32 that the file data have been written.

When the main data object management table does not include any entry having the same main data object ID, the data object storage management unit 34 registers the storage destination address information to the entry of the main data object which is the data writing target. Further, the data object storage management unit 34 sets the main data object save completion flag of the entry to a state indicating that the saving processing has been finished. Further, the data object storage management unit 34 notifies the file data managing unit 32 that the file data have been written (step S213).

The file data managing unit 32 which has received the completion notification of writing of the file data transmits a writing completion notification of the file data and ID information of the file to which the file data are written to the request processing unit 31. The request processing unit 31 transmits the writing completion notification of the file data and the file ID information, which have been received, to the client apparatus 101, and finishes the writing processing of the file data.

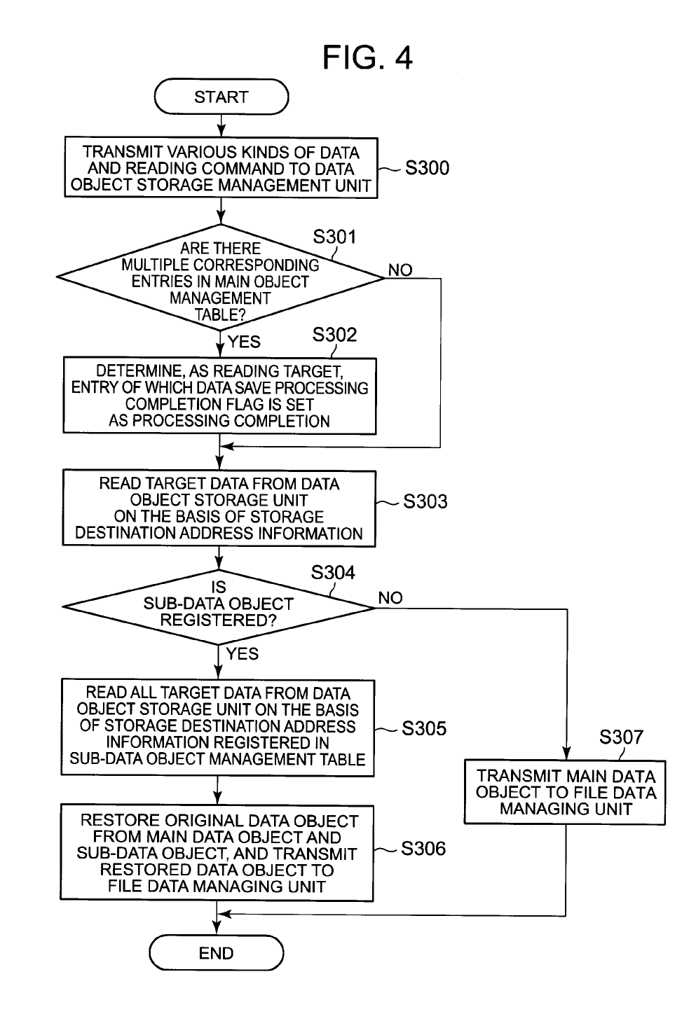

FIG. 4 is a flowchart illustrating file reading processing of the file storage apparatus illustrated in FIG. 1. Reading processing in which the file storage apparatus 30 reads file data in the storage system as illustrated in FIG. 1 will be explained with reference to FIG. 4.

First, the request processing unit 31 receives a file reading command for requesting reading of file data from the client apparatus 101, and file ID information of the file of which file data are to be read. Along with the transfer of the file reading command, the request processing unit 31 transmits the file ID information of the file to be read to the file data managing unit 32.

The file data managing unit 32 which has received the file reading command transmits, to the data object storage management unit 33, a data object reading command and a file ID information (step S300).

The data object storage management unit 33, which has received the data object reading command, searches an entry having the same main data object ID information as the received file ID information from the main data object management table. Then, the data object storage management unit 33 determines whether there are multiple entries having the ID information (step S301).

When there are multiple entries having the ID information in step S301, the data object storage management unit 33 adopts, as a reading target, a data object registered to an entry having a main data object save completion flag in a state indicating that the saving processing has been finished, from among the multiple corresponding entries (step S302).

When there is a single entry having the ID information in step S301, the data object storage management unit 33 adopts, as a reading target, a data object registered to the entry.

When the data object storage management unit 33 determines the data object of the reading target, the data object storage management unit 33 extracts the storage destination address information of the data object storage unit 36 from the entry of the data object determined as the reading target, and reads the corresponding data object from the data object storage unit 36 (step S303).

Then, the data object storage management unit 33 determines whether any sub-data object information is registered to the entry determined as the reading target (step S304).

When sub-data object information is registered to the entry determined as the reading target (Yes in step S304), the data object storage management unit 33 searches all the entries of the corresponding ID information from the sub-data object management table, on the basis of the sub-data object ID information registered to the sub-data object information. Thereafter, the data object storage management unit 33 extracts the storage destination address information of the data object storage unit 36 registered to the searched entries, and reads all the corresponding sub-data objects and the main data object from the data object storage unit 36 (step S305).

Further, the data object storage management unit 33 uses the main data object and the sub-data objects to restore a data object on the basis of the insertion position information of the sub-data objects registered to the entry determined as the reading target. Then, the data object storage management unit 33 transfers the restored data object to the file data managing unit 32 as reading target data (step S306).

When no sub-data object information is registered to the entry determined as the reading target (No in step S304), the data object storage management unit 33 transfers the main data object, which is read from the data object storage unit 36 in step S303, to the file data managing unit 32 as reading target data (step S307).

The file data managing unit 32 which has received the reading target data transmits a reading completion notification of file data and ID information of a read file to the request processing unit 31. The request processing unit 31 transmits the reading completion notification of the file data and the file ID information, which have been received, to the client apparatus 101, and finishes the reading processing of the file data.

It should be noted that when there is no entry having a main data object save completion flag in a state indicating that the saving processing has been finished regardless of the number of existing entries having the same main data object ID information as the file ID information received from the file data managing unit 32 in step S301, the data object storage management unit 33 notifies the file data managing unit 32 that there is no data object to be read.

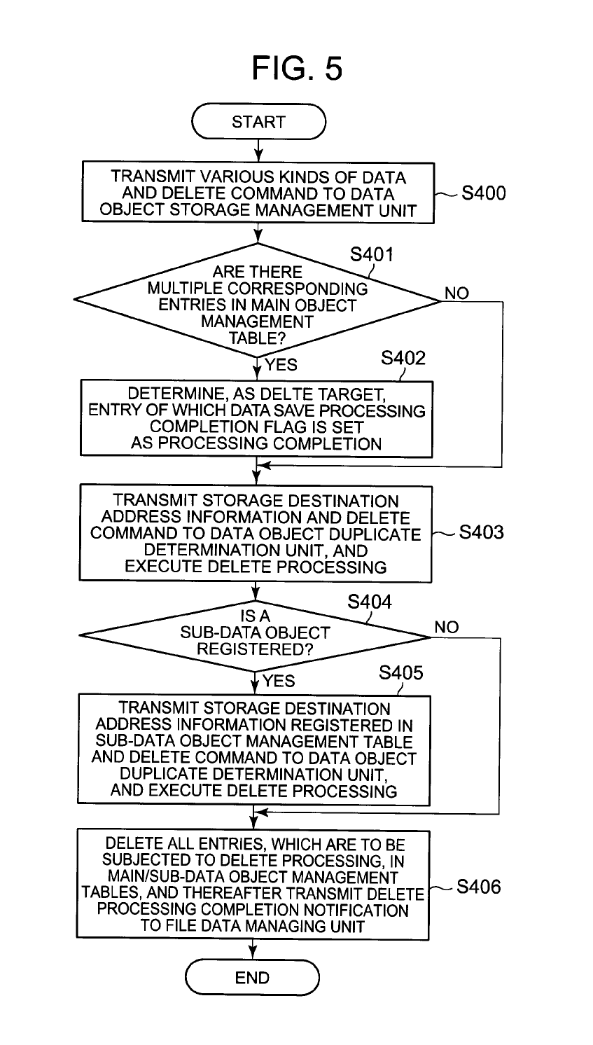

FIG. 5 is a flowchart illustrating file delete processing of the file storage apparatus illustrated in FIG. 1. Processing in which the file storage apparatus 30 deletes a file in the storage system as illustrated in FIG. 1 will be explained with reference to FIG. 5.

First, the request processing unit 31 receives a file delete command for requesting deleting of a file and a file ID of the file to be deleted from the client apparatus 101. Along with the transfer of the file delete command, the request processing unit 31 transmits the file ID information of the file to be deleted to the file data managing unit 32.

The file data managing unit 32 which has received the file delete command transmits a data object delete command and file ID information to the data object storage management unit 33 (step S400).

The data object storage management unit 33, which has received the data object delete command, searches an entry having the same main data object ID information as the received file ID information from the main data object management table, and determines whether there are multiple entries having the ID information (step S401).

When there are multiple entries having the ID information in step S401, the data object storage management unit 33 adopts, as a delete target, a data object registered to an entry having a main data object save completion flag in a state indicating that the saving processing has been finished, from among the multiple corresponding entries (step S402).

When there is a single entry having the ID information in step S401, the data object storage management unit 33 adopts, as a delete target, a data object registered to the entry.

When the data object storage management unit 33 determines the data object of the delete target, the data object storage management unit 33 extracts storage destination address information of the data object storage unit 36 from the entry of the data object determined as the reading target. Then, the data object storage management unit 33 transmits a delete command for deleting the data object as well as the extracted storage destination address information to the data object duplicate determination unit 35. The data object duplicate determination unit 35 which has received the delete command the storage destination address from the data object storage management unit 33 executes delete processing on the basis of the received storage destination address information. When the delete processing is finished, the data object duplicate determination unit 35 notifies the data object storage management unit 33 that the delete processing has been finished (step S403).

Further, in step S403, the data object storage management unit 33 which has received a completion notification of the delete processing determines whether sub-data object information is registered to the entry determined as the delete target (step S404). When no sub-data object information is registered to the entry determined as the delete target (No in step S404), processing as shown in step S406 will be subsequently performed.

When sub-data object information is registered to the entry determined as the delete target (Yes in step S404), the data object storage management unit 33 searches all the entries of the corresponding ID information from the sub-data object management table, on the basis of the sub-data object ID information registered to the sub-data object information. Thereafter, the data object storage management unit 33 extracts the storage destination address information of the data object storage unit 36 registered to the searched entries. Then, the data object storage management unit 33 transmits a data object delete command for deleting all the corresponding sub-data objects as well as the extracted storage destination address information to the data object duplicate determination unit 35.

The data object duplicate determination unit 35 which has received the delete command and the storage destination address from the data object storage management unit 33 executes delete processing on the basis of the received storage destination address information. When the delete processing is finished, the data object duplicate determination unit 35 notifies the data object storage management unit 33 that the delete processing has been finished (step S405).

According to processing shown in “No” of step S403 or step S405, the data object storage management unit 33 which has received the completion notification of the delete processing from the data duplicate determination unit 35 deletes all entries adopted as delete processing target of the main data object management table and the sub-data object management table. Then, the data object storage management unit 33 transmits the completion notification of the delete processing to the file data managing unit 32 (step S406).

The file data managing unit 32 which has received the completion notification of the delete processing of the file data transmits a delete completion notification of file and ID information of the deleted file to the request processing unit 31. The request processing unit 31 transmits a delete completion notification of the transmitted file and file ID information of the file to the client apparatus 101, and finishes processing for deleting the file.

It should be noted that when there is no entry having a main data object save completion flag in a state indicating that the saving processing has been finished regardless of the number of existing entries having the same main data object ID information as the file ID information received from the file data managing unit 32 in step S401, the data object storage management unit 33 notifies the file data managing unit 32 that there is no data object to be deleted.

An embodiment of this invention has been described in detail with reference to drawings, but the specific configuration is not limited to the above, and various kinds of design change and the like can be made without deviating from the gist of this invention.

The file storage apparatus 30 has a computer system therein. Operation of each processing unit of the above file storage apparatus 30 is stored to a computer-readable recording medium in a program format, and the above processing is performed by causing a computer to read and execute this program. In this case, the computer-readable recording medium may be a magnetic disk, a magneto optical disk, a CD-ROM, a DVD-ROM, and a semiconductor memory, and the like. This computer program may be distributed to the computer via a communication circuit, and the computer receiving this distribution may execute the program.

The above program may be configured to achieve only some of the functions explained above. Further, the above program may be a so-called differential file (differential program), which can achieve the above functions with a combination of a program already recorded to the computer system.

As explained above, the file storage apparatus 30 of the present embodiment, the data object duplicate determination unit 35 determines whether file data to be registered matches a data object stored in the data object storage unit 36 of the file storage apparatus 30, in units of data objects constituting the file data in accordance with the file format.

The file storage apparatus 30 makes the duplicate determination in units of data objects suitable as data change units executed by, e.g., a user terminal or an application generating file data. Therefore, only the data objects changed by, e.g., the user terminal or the application are stored to the data object storage unit 36 of the file storage apparatus 30, and on the other hand, it is not necessary to store non-changed data objects to the data object storage unit 36 as repeated data objects. Therefore, the physical capacity of data to be stored to the file storage apparatus 30 is further reduced, and the cost of storing the file data can be further reduced.

The file storage apparatus 30 makes the duplicate determination using a hash value representing a data object generated by the hash function. Therefore, the processing cost required to execute the duplicate determination on the file storage apparatus 30 can be reduced as compared with a case where the duplicate determination is performed in units of physical data blocks. In particular, a storage processing expected to execute high-speed data input/output processing (I/O processing) performs not only the I/O processing but also duplicate determination at the same time, and therefore, the I/O processing performance is expected to degrade less greatly.

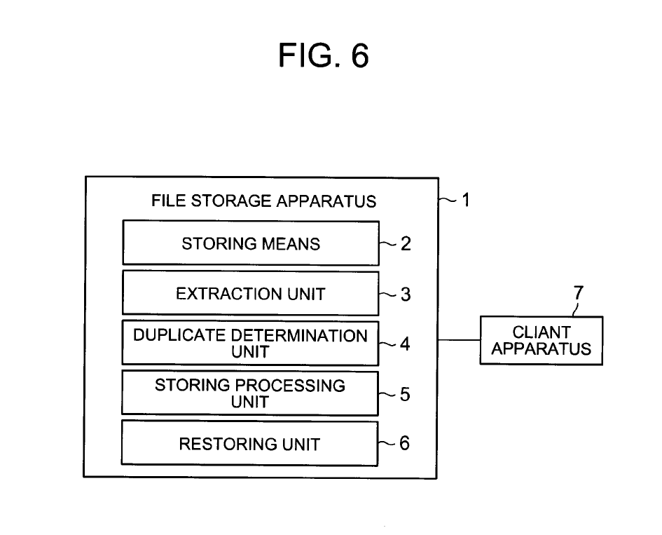

FIG. 6 is a block diagram illustrating a main portion of the file storage apparatus according to this invention. As shown in FIG. 6, a file storage apparatus 1 (for example, this corresponds to the file storage apparatus 30 as shown in FIG. 1) includes an extraction unit 3 (for example, this corresponds to the file format determination/extraction unit 34 as shown in FIG. 2) which extracts, in accordance with a format of a file which a client apparatus 7 (for example, this corresponds to the client apparatus 101 as shown in FIG. 1) requests the file storage apparatus 1 to store to storing means 2 (for example, this corresponds to the data object storage unit 36 as shown in FIG. 2), data possibly made into independent data as a independent file from the file which is data in a portion that can be stored to the storing means 2 (this corresponds to the sub-data object), a duplicate determination unit 4 (for example, this corresponds to the data object duplicate determination unit 35 as shown in FIG. 2) which determines whether the storing means 2 stores data matching the data possibly made into independent data that is extracted by the extraction unit 3 or remaining data which are data obtained by deleting the data possibly made into independent data from the file (this corresponds to the main data object), a storing processing unit 5 (for example, this corresponds to the data object storage management unit 33 as shown in FIG. 2) which stores, to the storing means 2, the data possibly made into independent data or the remaining data which do not match data stored to the storing means 2, on the basis of the determination result made by the duplicate determination unit 4, and a restoring unit 6 (for example, this corresponds to the data object storage management unit 33 as shown in FIG. 2) which restores a file by connecting the remaining data and the data possibly made into independent data which are stored to the storing means 2 by the storing processing unit 5, in accordance with a request made by the client apparatus 7.

In the above embodiments, a file storage apparatus as shown in the following (1) to (4) is also disclosed.

(1) The file storage apparatus, wherein when the extraction unit 3 extracts the data possibly made into independent data from the file which the client apparatus 7 requests to store to the storing means 2, the extraction unit deletes the data possibly made into independent data from the file, and generates connection position information indicating a connection position between the remaining data and the data possibly made into independent data, and the restoring unit 6 restores the file by connecting, at a connection position indicated by the connection position information, the remaining data and the data possibly made into independent data stored to the storing means 2, in accordance with a request given by the client apparatus 7. In this configuration, a file can be restored by connecting the data possibly made into independent data and the remaining data separately stored to the storing means 2.

(2) The file storage apparatus, wherein the duplicate determination unit 4 includes a hash value calculation unit respectively calculates hash values of the remaining data and the data possibly made into independent data stored to the storing means 2, and a hash table to which the hash value calculation unit registers the calculated hash values, and when the hash value of the remaining data or the hash value of the data possibly made into independent data calculated by the hash value calculation unit match a hash value registered to the hash table, the duplicate determination unit determines data that match the remaining data or the data possibly made into independent data to be stored to the storing means 2. In this configuration, repeated data are prevented from being stored, on the basis of the hash values.

(3) The file storage apparatus, wherein the hash table registers storage destination information indicating a location where data of which hash value is calculated by the hash value calculation unit are stored to the storing means, and a hash value of the data, which are associated with each other, and when the hash value of the remaining data or the hash value of the data possibly made into independent data calculated by the hash value calculation unit match a hash value registered to the hash table, the duplicate determination unit 4 reads the data stored at the location indicated by the storage destination information associated with the hash value registered to the hash table, and when a byte string of the read data is consistent with a byte string of the remaining data or the data possibly made into independent data, the duplicate determination unit determines data that match the remaining data or the data possibly made into independent data to be stored to the storing means 2. In this configuration, falsely detecting repeated data can be prevented when the same hash value is calculated on the basis of different data objects.

(4) The file storage apparatus, wherein the extraction unit 3 extracts, as the data possibly made into independent data, binary data that can be restored by the restoring unit 6 from the file in accordance with the format of the file which the client apparatus 7 requests to store to storing means 2.

The invention of the present application has been hereinabove explained with reference to embodiments and examples, but the invention of the present application is not limited to the embodiments and the examples. Various changes which can be understood by a person skilled in the art within the scope of the invention of the present application can be made to the configuration and the details of the invention of the present application.

This application claims priority based on Japanese Patent Application No. 2010-75766 filed on Mar. 29, 2010, and the entire disclosure thereof is incorporated herein by reference.

### INDUSTRIAL APPLICABILITY

This invention can be applied to a file storage apparatus of which object is to share files generated by users in an environment where many files partially including the same byte strings are expected.

### REFERENCE SIGNS LIST

1 File storage apparatus
2 Storing means
3 Extraction unit
4 Duplicate determination unit
5 Storing processing unit
6 Restoring unit
7 Client apparatus
101, 10n Client apparatus
20 Network
30 File storage apparatus
31 Request processing unit
32 File data managing unit
33 Data object storage management unit
34 File format determination/extraction unit
35 Data object duplicate determination unit
36 Data object storage unit

What is claimed is:

1.-9. (canceled)

10. A file storage apparatus having storing means for storing data in accordance with a request given by a client apparatus, comprising:
an extraction unit which extracts, in accordance with a format of a file which the client apparatus requests the file storage apparatus to store to storing means, data possibly made into independent data as a independent file from the file which is data in a portion that can be stored to the storing means;
a duplicate determination unit which determines whether the storing means stores data matching the data possibly made into independent data that is extracted by the extraction unit or remaining data which are data obtained by deleting the data possibly made into independent data from the file;
a storing processing unit which stores, to the storing means, the data possibly made into independent data or the remaining data which do not match data stored to the storing means, on the basis of the determination result made by the duplicate determination unit; and
a restoring unit which restores a file by connecting the remaining data and the data possibly made into independent data which are stored to the storing means by the storing processing unit, in accordance with a request made by the client apparatus.

11. The file storage apparatus according to claim 10, wherein
when the extraction unit extracts the data possibly made into independent data from the file which the client apparatus requests the file storage apparatus to store to the storing means, the extraction unit deletes the data possibly made into independent data from the file, and generates connection position information indicating a connection position between the remaining data and the data possibly made into independent data, and
the restoring unit restores the file by connecting, at a connection position indicated by the connection position information, the remaining data and the data possibly made into independent data stored to the storing means, in accordance with a request given by the client apparatus.

12. The file storage apparatus according to claim 10, wherein
the duplicate determination unit includes a hash value calculation unit respectively calculates hash values of the remaining data and the data possibly made into independent data stored to the storing means, and a hash table to which the hash value calculation unit registers the calculated hash values, and
when the hash value of the remaining data or the hash value of the data possibly made into independent data calculated by the hash value calculation unit match a hash value registered to the hash table, the duplicate determination unit determines data that match the remaining data or the data possibly made into independent data to be stored to the storing means.

13. The file storage apparatus according to claim 12, wherein
the hash table registers storage destination information indicating a location where data of which hash value is calculated by the hash value calculation unit are stored to the storing means, and a hash value of the data, which are associated with each other, and
when the hash value of the remaining data or the hash value of the data possibly made into independent data calculated by the hash value calculation unit match a hash value registered to the hash table, the duplicate determination unit reads the data stored at the location indicated by the storage destination information associated with the hash value registered to the hash table, and when a byte string of the read data is consistent with a byte string of the remaining data or the data possibly made into independent data, the duplicate determination unit determines data that match the remaining data or the data possibly made into independent data to be stored to the storing means.

14. The file storage apparatus according to claim 10, wherein the extraction unit extracts, as the data possibly made into independent data, binary data that can be restored by the restoring unit from the file in accordance with the format of the file which the client apparatus requests the file storage apparatus to store to storing means.

15. A data storing method for storing data to storing means of a file storage apparatus in accordance with a request given by a client apparatus, comprising:
extracting, in accordance with a format of a file which the client apparatus requests the file storage apparatus to store to storing means, data possibly made into independent data as a independent file from the file which is data in a portion that can be stored to the storing means;
determining whether the storing means stores data matching the extracted data possibly made into independent data or remaining data which are data obtained by deleting the data possibly made into independent data from the file;
storing, to the storing means, the data possibly made into independent data or the remaining data which do not match data stored to the storing means, on the basis of the determination result; and
restoring a file by connecting the remaining data and the data possibly made into independent data which are stored to the storing means, in accordance with a request made by the client apparatus.

16. The data storing method according to claim 15, wherein
when the data possibly made into independent data are extracted from the file which the client apparatus requests the file storage apparatus to store to the storing means, deleting the data possibly made into independent data from the file, and generating connection position information indicating a connection position between the remaining data and the data possibly made into independent data, and
restoring the file by connecting, at a connection position indicated by the connection position information, the remaining data and the data possibly made into independent data stored to the storing means, in accordance with a request given by the client apparatus.

17. A computer readable information recording medium storing a data storing program provided in a file storage apparatus having storing means for storing data in accordance with a request given by a client apparatus, when executed by a processor, performs a method for:
extracting, in accordance with a format of a file which the client apparatus requests the file storage apparatus to store to storing means, data possibly made into independent data as a independent file from the file which is data in a portion that can be stored to the storing means;
determining whether the storing means stores data matching the extracted data possibly made into independent data or remaining data which are data obtained by deleting the data possibly made into independent data from the file;
storing, to the storing means, the data possibly made into independent data or the remaining data which do not match data stored to the storing means, on the basis of the determination result; and
restoring a file by connecting the remaining data and the data possibly made into independent data which are stored to the storing means, in accordance with a request made by the client apparatus.

18. The computer readable information recording medium according to claim 17,
when the data possibly made into independent data are extracted from the file which the client apparatus requests the file storage apparatus to store to the storing means, deleting the data possibly made into independent data from the file, and generate connection position information indicating a connection position between the remaining data and the data possibly made into independent data, and
restoring the file by connecting, at a connection position indicated by the connection position information, the remaining data and the data possibly made into independent data stored to the storing means, in accordance with a request given by the client apparatus.
